(19) United States
(12) Patent Application Publication
(10) Pub. No.: US 2022/0406324 A1
(43) Pub. Date: Dec. 22, 2022

(54) ELECTRONIC DEVICE AND PERSONALIZED AUDIO PROCESSING METHOD OF THE ELECTRONIC DEVICE

(71) Applicant: Samsung Electronics Co., Ltd., Gyeonggi-do (KR)

(72) Inventors: Hoseon SHIN, Gyeonggi-do (KR); Chulmin LEE, Gyeonggi-do (KR); Seongkyu MUN, Gyeonggi-do (KR); Changwoo HAN, Gyeonggi-do (KR); Youngwoo LEE, Gyeonggi-do (KR)

(21) Appl. No.: 17/830,763

(22) Filed: Jun. 2, 2022

Related U.S. Application Data
(63) Continuation-in-part of application No. PCT/KR2022/005415, filed on Apr. 14, 2022.

(30) Foreign Application Priority Data
Jun. 18, 2021 (KR) 10-2021-0079419

(51) Int. Cl. G10L 21/0208; G10L 21/0272; G10L 25/78; G06N 3/04

(52) U.S. Cl. CPC G10L 21/0208; G10L 21/0272; G10L 25/78; G06N 3/0454

(57) ABSTRACT

According to an embodiment, an electronic device, comprises: a microphone configured to receive an audio signal comprising a speech of a user; a memory storing instructions therein; and a processor electrically connected to the memory and configured to execute the instructions, wherein execution of the instructions by the processor, causes the processor to perform a plurality of operations, the plurality of operations comprising: removing noise from the audio signal, thereby generating a first output result; performing speaker separation on the audio signal on the audio signal or the first output result, thereby generating a second output result; and processing a command corresponding to the audio signal based on the first output result and the second output result.

### CROSS-REFERENCE TO RELATED APPLICATIONS

This application is a Continuation of PCT application No. PCT/KR2022/005415 filed on Apr. 14, 2022 and claims the benefit under 35 USC § 119(a) of Korean Patent Application No. 10-2021-0079419 filed on Jun. 18, 2021, in the Korean Intellectual Property Office, the entire disclosure of which is incorporated herein by reference for all purposes.

### BACKGROUND

### 1. Field

The disclosure relates to an electronic device and a personalized audio processing method of the electronic device.

### 2. Description of Related Art

A voice assistant of an electronic device may be executed in various forms. For example, there may be a predetermined wake-up word that is used to start the voice assistance. The voice assistant may perform a command uttered after a wake-up keyword by a user. The voice assistant can also perform the uttered command through software and hardware keys, without the wake-up keyword.

However, when others around the user utter a speech or strong noise is included in a voice component while the voice assistant is receiving the command, an utterance (or the voice command) of the user may not be desirably recognized. For example, if the user utters the command, “call the police station” after the wake-up word, but another user says in conversation, “Next Monday, let's go to lunch”, the voice assistant may recognize the command as “call the police station next Monday.”

When an audio signal including a mixture of utterances of the user and the others is received during the execution of the voice assistant, an unintended result (e.g., the addition of a signal unrelated to a command of the user or the distortion of the command) may be output.

A typical speech recognition method may use personalized preprocessing including generating a single speaker embedding from a preset audio source and estimating a mask filter, thereby improving only a speech or voice of a single speaker. However, despite the use of personalized preprocessing, an utterance of a user may not be provided in the form with utterances of others completely removed.

### SUMMARY

According to an embodiment, an electronic device, comprises: a microphone configured to receive an audio signal comprising a speech of a user; a memory storing instructions therein; and a processor electrically connected to the memory and configured to execute the instructions, wherein execution of the instructions by the processor, causes the processor to perform a plurality of operations, the plurality of operations comprising: removing noise from the audio signal, thereby generating a first output result; performing speaker separation on the audio signal on the audio signal or the first output result, thereby generating a second output result; and processing a command corresponding to the audio signal based on the first output result and the second output result.

According to certain embodiments, an electronic device, comprises: a microphone configured to receive an audio signal comprising a speech of a user; a memory storing therein instructions; and a processor electrically connected to the memory and configured to execute the instructions, wherein, when the instructions are executed by the processor, the instructions cause the processor to perform a plurality of operations, the plurality of operations comprising: determining a preprocessing mode for the audio signal as a first option is selected through a user interface (UI); determining a type of input data for processing the audio signal as a second option is selected through the UI; and process a command corresponding to the audio signal based on the preprocessing mode and the type of the input data.

According to certain embodiments, a method comprises: receiving an audio signal comprising a speech of a user; removing noise from the audio signal, thereby generating a first output result; performing speaker separation on the audio signal or the first output result, thereby generating a second output result; and processing a command corresponding to the audio signal based on the first output result and the second output result.

Other features and aspects will be apparent from the following detailed description, the drawings, and the claims.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example electronic device in a network environment according to an embodiment;

FIG. 2 is a block diagram illustrating an example integrated intelligence system according to an embodiment;

FIGS. 3A through 3D are diagrams illustrating examples of a personalized preprocessing interface according to embodiments;

FIGS. 4A through 4C are diagrams illustrating examples of an operation of the electronic device of FIG. 1;

FIG. 5 is a diagram illustrating an example of a network for generating an embedding vector according to an embodiment;

FIG. 6 is a diagram illustrating an example of a network for generating an output result according to an embodiment;

FIGS. 7A through 7C are diagrams illustrating examples of a first output result and a second output result according to an embodiment;

FIGS. 8A through 9B are diagrams illustrating examples of a result of processing a command of a user in response to selection of options from a user interface (UI) according to embodiments; and

FIG. 10 is a flowchart illustrating an example of a method of operating the electronic device of FIG. 1.

### DETAILED DESCRIPTION

Hereinafter, certain embodiments will be described in greater detail with reference to the accompanying drawings. When describing the embodiments with reference to the accompanying drawings, like reference numerals refer to like elements and a repeated description related thereto will be omitted.

### Electronic Device

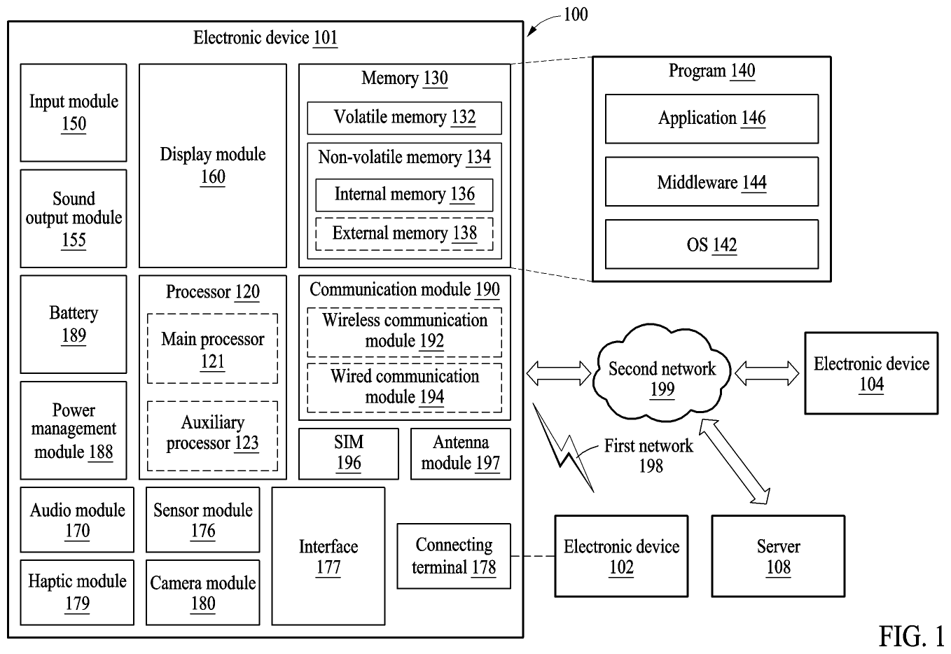

FIG. 1 is a block diagram illustrating an example of an electronic device in a network environment according to an embodiment. It shall be understood electronic devices are not limited to the following, may omit certain components, and may add other components. Referring to FIG. 1, an electronic device 101 in a network environment 100 may communicate with an electronic device 102 via a first network 198 (e.g., a short-range wireless communication network), or communicate with at least one of an electronic device 104 and a server 108 via a second network 199 (e.g., a long-range wireless communication network). The electronic device 101 may communicate with the electronic device 104 via the server 108. The electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added in the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101. The processor 120 may also perform various data processing or computation. The processor 120 may store a command or data received from another component (e.g., the sensor module 176 or the communication module 190) in a volatile memory 132, process the command or data stored in the volatile memory 132, and store resulting data in a non-volatile memory 134. The processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The term “processor” shall be understood to include both the singular and the plural contexts in this disclosure.

The auxiliary processor 123 may control at least some of functions or states related to at least one (e.g., the display device 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). The auxiliary processor 123 (e.g., an ISP or a CP) may be implemented as a portion of another component (e.g., the camera module 180 or the communication module 190) that is functionally related to the auxiliary processor 123. The auxiliary processor 123 (e.g., an NPU) may include a hardware structure specified for artificial intelligence (AI) model processing. An AI model may be generated by machine learning. Such learning may be performed by, for example, the electronic device 101 in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may alternatively or additionally include a software structure other than the hardware structure.

The memory 130 may store various data used by at least one component (e.g., the processor 120 or the sensor module 176) of the electronic device 101. The data may include, for example, software (e.g., the program 140) and input data or output data for a command related thereto. The memory 130 may include the volatile memory 132 or the non-volatile memory 134. The non-volatile memory 134 may include an internal memory 136 and an external memory 138.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing records. The receiver may be used to receive an incoming call. The receiver may be implemented separately from the speaker or as a part of the speaker.

The display module 160 may visually provide information to the outside (e.g., a user) of the electronic device 101. The display module 160 may include, for example, a display, a hologram device, or a projector, and a control circuitry to control a corresponding one of the display, the hologram device, and the projector. The display module 160 may include a touch sensor adapted to sense a touch, or a pressure sensor adapted to measure an intensity of a force incurred by the touch.

The audio module 170 may convert a sound into an electric signal or vice versa. The audio module 170 may obtain the sound via the input module 150 or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with an external electronic device (e.g., the electronic device 102) directly (e.g., wiredly) or wirelessly. The interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). The connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. The haptic module 179 may include, for example, a motor, a piezoelectric element, or an electric stimulator.

The camera module 180 may capture a still image and moving images. The camera module 180 may include one or more lenses, image sensors, ISPs, or flashes.

The power management module 188 may manage power supplied to the electronic device 101. The power management module 188 may be implemented as, for example, at least a part of a power management integrated circuit (PMIC).

The battery 189 may supply power to at least one component of the electronic device 101. The battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and an external electronic device (e.g., the electronic device 102, the electronic device 104, or the server 108) and performing communication via the established communication channel. The communication module 190 may include one or more communication processors that are operable independently of the processor 120 (e.g., an AP) and that support direct (e.g., wired) communication or wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multiple components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beamforming, or a large scale antenna. The wireless communication module 192 may support various requirements specified in the electronic device 101, an external electronic device (e.g., the electronic device 104), or a network system (e.g., the second network 199). The wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. The antenna module 197 may include an antenna including a radiating element including a conductive material or a conductive pattern formed in or on a substrate (e.g., a printed circuit board (PCB)). The antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

The antenna module 197 may form a mmWave antenna module. The mmWave antenna module may include a PCB, an RFIC disposed on a first surface (e.g., a bottom surface) of the PCB or adjacent to the first surface and capable of supporting a designated high-frequency band (e.g., the mmWave band), and a plurality of antennas (e.g., array antennas) disposed on a second surface (e.g., a top or a side surface) of the PCB or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general-purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the external electronic devices 102 and 104 may be a device of the same type as or a different type from the electronic device 101. All or some of operations to be executed by the electronic device 101 may be executed at one or more of the external electronic devices 102, 104, and 108. For example, if the electronic device 101 needs to perform a function or a service automatically, or in response to a request from a user or another device, the electronic device 101, instead of, or in addition to, executing the function or the service, may request one or more external electronic devices to perform at least a part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least a part of a reply to the request. To that end, a cloud computing, distributed computing, mobile edge computing (MEC), or client-server computing technology may be used, for example. The electronic device 101 may provide ultra-low latency services using, e.g., distributed computing or mobile edge computing. In an embodiment, the external electronic device 104 may include an Internet-of-things (IoT) device. The server 108 may be an intelligent server using machine learning and/or a neural network. The external electronic device 104 or the server 108 may be included in the second network 199. The electronic device 101 may be applied to intelligent services (e.g., smart home, smart city, smart car, or healthcare) based on 5G communication technology or IoT-related technology.

An electronic device described herein may be a device of one of various types. The electronic device may include, as non-limiting examples, a portable communication device (e.g., a smartphone, etc.), a computing device, a portable multimedia device, a portable medical device, a camera, a wearable device, or a home appliance. However, the electronic device is not limited to the foregoing examples.

It should be construed that certain embodiments of the present disclosure and the terms used therein are not intended to limit the technological features set forth herein to some particular embodiments but include various changes, equivalents, or replacements of the embodiments. In connection with the description of the drawings, like reference numerals may be used for similar or related components. It should be understood that a singular form of a noun corresponding to an item may include one or more of the things, unless the relevant context clearly indicates otherwise. As used herein, “A or B,” “at least one of A and B,” “at least one of A or B,” “A, B, or C,” “at least one of A, B, and C,” and “A, B, or C,” each of which may include any one of the items listed together in the corresponding one of the phrases, or all possible combinations thereof Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure. It should also be understood that, when a component (e.g., a first component) is referred to as being “connected to” or “coupled to” another component with or without the term “functionally” or “communicatively,” the component can be connected or coupled to the other component directly (e.g., wiredly), wirelessly, or via a third component.

As used in connection with certain embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

Certain embodiments set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to certain embodiments, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities, and some of the multiple entities may be separately disposed in different components. According to certain embodiments, one or more of the above-described components or operations may be omitted, or one or more other components or operations may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

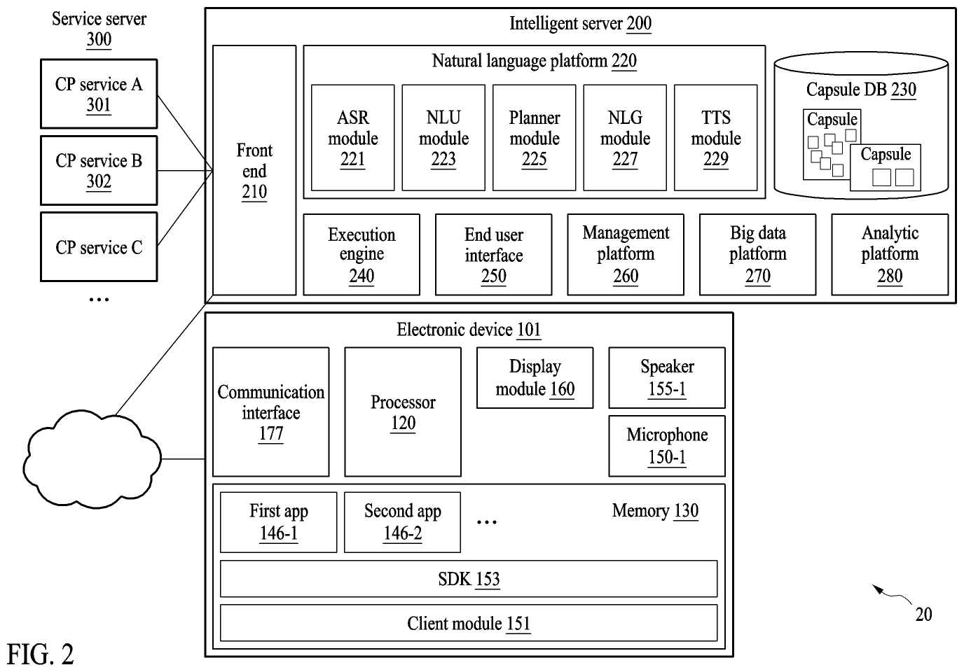

The audio module 170 can receive voice commands. For example, the audio module 170 can receive a wake-up command followed by an utterance. An integrated intelligence system can convert the utterance into a command, which is then executed by the processor 120. FIG. 2 shows an integrated intelligence system.

### Integrated Intelligence System

FIG. 2 is a block diagram illustrating an example integrated intelligence system according to an embodiment.

Referring to FIG. 2, according to an embodiment, an integrated intelligence system 20 may include an electronic device 101 (e.g., the electronic device 101 of FIG. 1), an intelligent server 200 (e.g., the server 108 of FIG. 1), and a service server 300 (e.g., the server 108 of FIG. 1).

The electronic device 101 may be a terminal device (or an electronic device) that is connectable to the Internet, for example, a mobile phone, a smartphone, a personal digital assistant (PDA), a laptop computer, a television (TV), a white home appliance, a wearable device, a head-mounted display (HMD), or a smart speaker.

As illustrated, the electronic device 101 may include a communication interface (e.g., the interface 177 of FIG. 1), a microphone 150-1 (e.g., the input module 150 of FIG. 1), a speaker 155-1 (e.g., the sound output module 155 of FIG. 1), a display module 160 (e.g., the display module 160 of FIG. 1), a memory 130 (e.g., the memory 130 of FIG. 1), or a processor 120 (e.g., the processor 120 of FIG. 1). The components listed above may be operationally or electrically connected to each other.

The communication interface 177 may be connected to an external device to transmit and receive data to and from the external device. The microphone 150-1 may receive a sound (e.g., a user utterance) and convert the sound into an electrical signal. The speaker 155-1 may output the electrical signal as a sound (e.g., a voice or speech).

The display module 160 may display an image or video. The display module 160 may also display a graphical user interface (GUI) of an app (or an application program) being executed. The display module 160 may receive a touch input through a touch sensor. For example, the display module 160 may receive a text input through the touch sensor in an on-screen keyboard area displayed on the display module 160.

The memory 130 may store a client module 151, a software development kit (SDK) 153, and a plurality of apps 146. The client module 151 and the SDK 153 may configure a framework (or a solution program) for performing general-purpose functions. In addition, the client module 151 or the SDK 153 may configure a framework for processing a user input (e.g., a voice input, a text input, and a touch input).

The apps 146 stored in the memory 130 may be programs for performing designated functions. The apps 146 may include a first app 146_1, a second app 146_2, and the like. The apps 146 may each include a plurality of actions for performing a designated function. For example, the apps 146 may include an alarm app, a message app, and/or a scheduling app. The apps 146 may be executed by the processor 120 to sequentially execute at least a portion of the actions.

The processor 120 may control the overall operation of electronic device 101. For example, the processor 120 may be electrically connected to the communication interface 177, the microphone 150-1, the speaker 155-1, and the display module 160 to perform a designated operation.

The processor 120 may also perform a designated function by executing a program stored in the memory 130. For example, the processor 120 may execute at least one of the client module 151 or the SDK 153 to perform the following operations for processing a user input. For example, the processor 120 may control the actions of the apps 146 through the SDK 153. The following operations described as operations of the client module 151 or the SDK 153 may be operations to be performed by the execution of the processor 120.

The client module 151 may receive a user input. For example, the client module 151 may receive an audio signal corresponding to an utterance of a user sensed through the microphone 150-1. An audio signal described herein may correspond to a voice or speech signal, and an utterance, a voice, and a speech may be interchangeably used herein. Alternatively, the client module 151 may receive a touch input sensed through the display module 160. Alternatively, the client module 151 may receive a text input sensed through a keyboard or an on-screen keyboard. The client module 151 may also receive, as non-limiting examples, various types of user input sensed through an input module included in the electronic device 101 or an input module connected to the electronic device 101. The client module 151 may transmit the received user input to the intelligent server 200. The client module 151 may transmit state information of the electronic device 101 together with the received user input to the intelligent server 200. The state information may be, for example, execution state information of an app.

The client module 151 may also receive a result corresponding to the received user input. For example, when the intelligent server 200 calculates the result corresponding to the received user input, the client module 151 may receive the result corresponding to the received user input, and display the received result on the display module 160. In addition, the client module 151 may output the received result in audio through the speaker 155-1.

The client module 151 may receive a plan corresponding to the received user input. The client module 151 may display, on the display module 160, execution results of executing a plurality of actions of an app according to the plan. For example, the client module 151 may sequentially display the execution results of the actions on the display module 160, and output the execution results in audio through the speaker 155-1. For another example, electronic device 101 may display only an execution result of executing a portion of the actions (e.g., an execution result of the last action) on the display module 160, and output the execution result in audio through the speaker 155-1.

The client module 151 may receive a request for obtaining information necessary for calculating the result corresponding to the user input from the intelligent server 200. The client module 151 may transmit the necessary information to the intelligent server 200 in response to the request.

The client module 151 may transmit information on the execution results of executing the actions according to the plan to the intelligent server 200. The intelligent server 200 may verify that the received user input has been correctly processed using the information.

The client module 151 may include a speech recognition module. The client module 151 may recognize a voice or speech input for performing a limited function through the speech recognition module. For example, the client module 151 may execute an intelligent app for processing the voice input to perform an organic action through a designated input (e.g., “Wake up!”).

The intelligent server 200 may receive information related to a user voice input from the electronic device 101 through a communication network. The intelligent server 200 may change data related to the received voice input into text data. The intelligent server 200 may generate a plan for performing a task corresponding to the user input based on the text data.

The plan may be generated by an artificial intelligence (AI) system. The AI system may be a rule-based system or a neural network-based system (e.g., a feedforward neural network (FNN) or a recurrent neural network (RNN)). Alternatively, the AI system may be a combination thereof or another AI system. The plan may also be selected from a set of predefined plans or may be generated in real time in response to a user request. For example, the AI system may select at least one plan from among the predefined plans.

The intelligent server 200 may transmit a result according to the generated plan to the electronic device 101 or transmit the generated plan to the electronic device 101. The electronic device 101 may display the result according to the plan on the display module 160. The electronic device 101 may display a result of executing an action according to the plan on the display module 160.

The intelligent server 200 may include a front end 210, a natural language platform 220, a capsule database (DB) 230, an execution engine 240, an end user interface 250, a management platform 260, a big data platform 270, or an analytic platform 280.

The front end 210 may receive a user input from the electronic device 101. The front end 210 may transmit a response corresponding to the user input.

The natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert a voice input received from the electronic device 101 into text data. The NLU module 223 may understand an intention of a user using the text data of the voice input. For example, the NLU module 223 may understand the intention of the user by performing a syntactic or semantic analysis on a user input in the form of text data. The NLU module 223 may understand semantics of words extracted from the user input using a linguistic feature (e.g., a grammatical element) of a morpheme or phrase, and determine the intention of the user by matching the semantics of the word to the intention.

The planner module 225 may generate a plan using the intention and a parameter determined by the NLU module 223. The planner module 225 may determine a plurality of domains required to perform a task based on the determined intention. The planner module 225 may determine a plurality of actions included in each of the domains determined based on the intention. The planner module 225 may determine a parameter required to execute the determined actions or a resulting value output by the execution of the actions. The parameter and the resulting value may be defined as a concept of a designated form (or class). Accordingly, the plan may include a plurality of actions and a plurality of concepts determined by a user intention. The planner module 225 may determine a relationship between the actions and the concepts stepwise (or hierarchically). For example, the planner module 225 may determine an execution order of the actions determined based on the user intention, based on the concepts. In other words, the planner module 225 may determine the execution order of the actions based on the parameter required for the execution of the actions and results output by the execution of the actions. Accordingly, the planner module 225 may generate the plan including connection information (e.g., ontology) between the actions and the concepts. The planner module 225 may generate the plan using information stored in the capsule DB 230 that stores a set of relationships between concepts and actions.

The NLG module 227 may change designated information to the form of a text. The information changed to the form of a text may be in the form of a natural language utterance. The TTS module 229 may change the information in the form of a text to information in the form of a speech. Although not illustrated, the TTS module 229 may include a personalized TTS (PTTS) module. The PTTS module may generate an audio signal (e.g., a PTTS audio source) based on a voice or speech of a designated user corresponding to a designated text (e.g., a wake-up keyword) using a PTTS model that is constructed (or trained) based on the voice of the user. The PTTS audio source may be stored in the memory 130.

According to an embodiment, all or some of the functions of the natural language platform 220 may also be implemented in the electronic device 101.

The capsule DB 230 may store therein information about relationships between a plurality of concepts and a plurality of actions corresponding to a plurality of domains. According to an embodiment, a capsule may include a plurality of action objects (or action information) and concept objects (or concept information) included in a plan. The capsule DB 230 may store a plurality of capsules in the form of a concept action network (CAN). The capsules may be stored in a function registry included in the capsule DB 230.

The capsule DB 230 may include a strategy registry that stores strategy information necessary for determining a plan corresponding to a user input, for example, a voice input. The strategy information may include reference information for determining one plan when there are a plurality of plans corresponding to the user input. The capsule DB 230 may include a follow-up registry that stores information on follow-up actions for suggesting a follow-up action to the user in a designated situation. The follow-up action may include, for example, a follow-up utterance. The capsule DB 230 may include a layout registry that stores layout information of information output through the electronic device 101. The capsule DB 230 may include a vocabulary registry that stores vocabulary information included in capsule information. The capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating a vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a currently set objective, a preference of the user, or an environmental condition. The capsule DB 230 may also be implemented in the electronic device 101.

The execution engine 240 may calculate a result using a generated plan. The end user interface 250 may transmit the calculated result to the electronic device 101. Accordingly, the electronic device 101 may receive the result and provide the received result to the user. The management platform 260 may manage information used by the intelligent server 290. The big data platform 270 may collect data of the user. The analytic platform 280 may manage a quality of service (QoS) of the intelligent server 290. For example, the analytic platform 280 may manage the components and processing rate (or efficiency) of the intelligent server 290.

The service server 300 may provide a designated service (e.g., food ordering or hotel reservation) to the electronic device 101. The service server 300 may be a server operated by a third party. The service server 300 may provide the intelligent server 200 with information to be used for generating a plan corresponding to a received user input. The provided information may be stored in the capsule DB 230. In addition, the service server 300 may provide resulting information according to the plan to the intelligent server 200.

In the integrated intelligence system 20 described above, the electronic device 101 may provide various intelligent services to a user in response to a user input. The user input may include, for example, an input through a physical button, a touch input, or a voice input.

The electronic device 101 may provide a speech recognition service through an intelligent app (or a speech recognition app) stored therein. In this case, the electronic device 101 may recognize a user utterance or a voice input received through the microphone 150-1, and provide a service corresponding to the recognized voice input to the user.

The electronic device 101 may perform a designated action alone or together with the intelligent server 200 and/or the service server 300 based on the received voice input. For example, the electronic device 101 may execute an app corresponding to the received voice input and perform the designated action through the executed app.

When the electronic device 101 provides the service together with the intelligent server 200 and/or the service server 300, the electronic device 101 may detect a user utterance using the microphone 150-1 and generate a signal (or voice data) corresponding to the detected user utterance. The electronic device 101 may transmit the voice data to the intelligent server 200 using the communication interface 177.

The intelligent server 200 may generate, as a response to the voice input received from the electronic device 101, a plan for performing a task corresponding to the voice input or a result of performing an action according to the plan. The plan may include, for example, a plurality of actions for performing the task corresponding to the voice input of the user, and a plurality of concepts related to the actions. The concepts may define parameters input to the execution of the actions or resulting values output by the execution of the actions. The plan may include connection information between the actions and the concepts.

The electronic device 101 may receive the response using the communication interface 177. The electronic device 101 may output an audio signal (or a voice signal) generated in the electronic device 101 to the outside using the speaker 155-1, or output an image generated in the electronic device 101 to the outside using the display module 160.

When others around the user utter a speech or strong noise is included in a voice component while the voice assistant is receiving the command, an utterance (or the voice command) of the user may not be desirably recognized. When an audio signal including a mixture of utterances of the user and the others is received during the execution of the voice assistant, an unintended result (e.g., the addition of a signal unrelated to a command of the user or the distortion of the command) may be output.

Accordingly, in certain embodiments, the electronic device 101 can include a personalized preprocessing interface. The personalized preprocessing interface can remove utterances of others, thereby resulting in more accurate command execution.

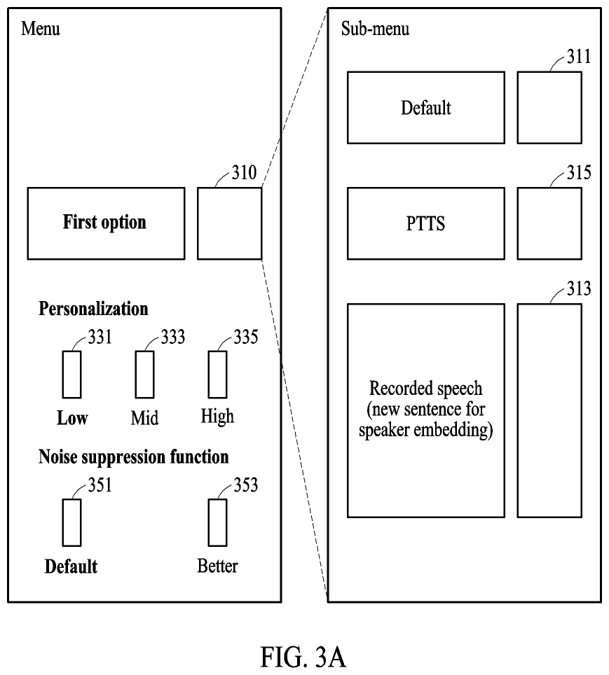

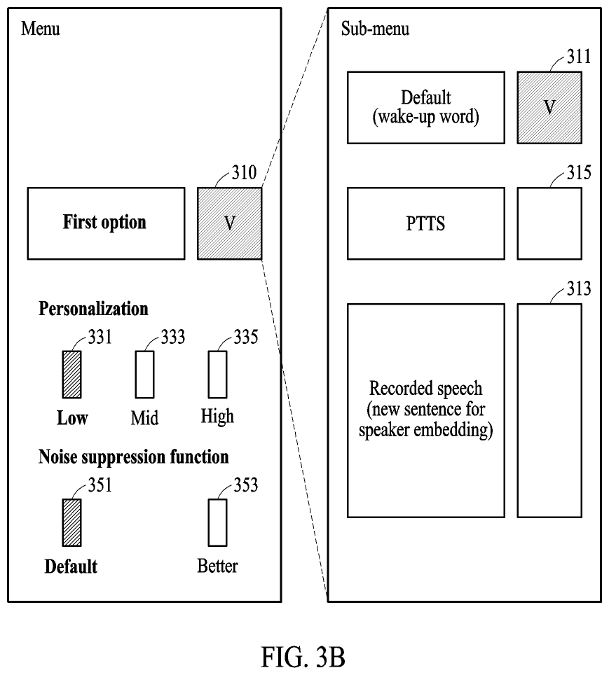

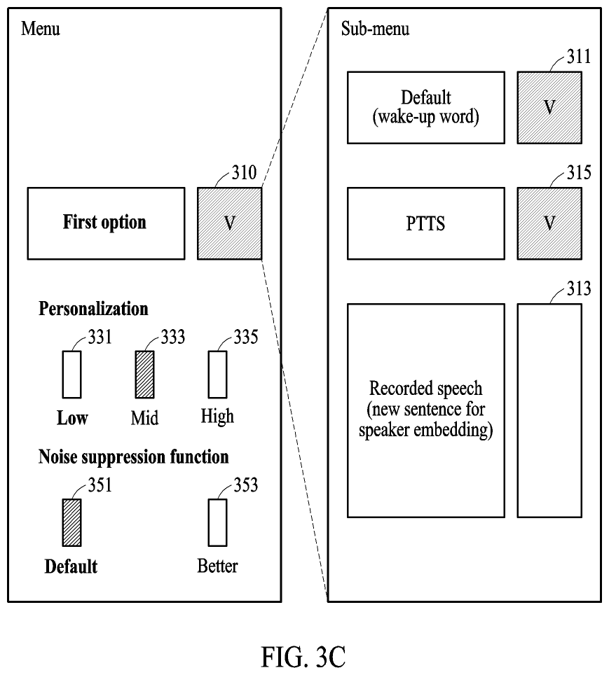

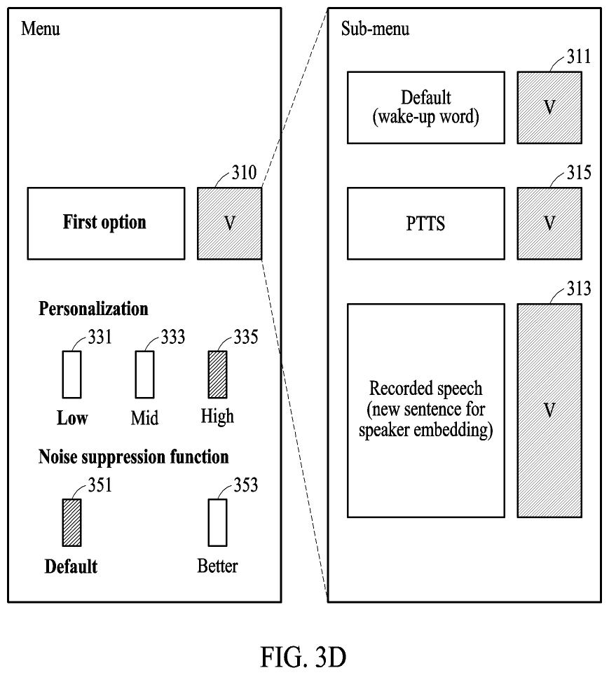

FIGS. 3A through 3D are diagrams illustrating examples of a personalized preprocessing interface according to embodiments.

According to an embodiment, a processor (e.g., the processor 120 of FIG. 1) may process an audio signal received from a microphone (e.g., the microphone 150-1 of FIG. 1). The microphone 150-1 may receive the audio signal including a speech of a user. The processor 120 may receive the audio signal and process a command corresponding to the received audio signal.

The processor 120 may receive a signal corresponding to selection of an option through a user interface (UI). The option may be associated with processing of the audio signal. For example, the processor 120 may receive a touch signal from a touch sensor included in a display module (e.g., the display module 160 of FIG. 1) as the option is selected by the user.

FIGS. 3A through 3D illustrate examples of a UI for audio signal processing. As illustrated in FIGS. 3A through 3D, the UI may be provided through the display module 160 by being included in a voice assistant application.

The UI may provide a plurality of selectable menu entries and sub-menu entries, as well as selectable objects. A menu of the UI may include a first option 310, personalized options 331, 333, and 335, and noise suppression options 351 and 353 for a noise suppression function. A sub-menu of the UI may include a default option 311, a speech recording option 313, and a PTTS option 315.

The personalized options may include a low option 331, a mid option 333, and a high option 335. The noise suppression options may include a default option 351 and a better option 353.

The first option 310 may be for determining a preprocessing mode. The personalized options 331, 333, and 335 may be for determining a type of input data for processing an audio signal. The noise suppression options 351 and 353 may be for determining a mask preprocessing mode for removing noise.

The processor 120 may determine whether to perform speaker separation on the audio signal as the first option 310 is selected. When the first option 310 is selected, the processor 120 may determine, at least one of a wake-up keyword uttered by the user, a PTTS audio source, or an additional speech of the user to be the input data,. The wake-up keyword may include “hi, bixby,” for example.

For example, in the presence of an audio sample in a memory (e.g., the memory 130 of FIG. 1) that includes a voice or speech of the user , the processor 120 may generate a speaker embedding vector as the first option 310 is selected (or an enable state). The speaker embedding vector may refer to a vector, or data structure that includes predetermined characteristic information (e.g., utterance speed, intonation, or (sound) pitch) specific to a user. In the absence of the audio sample including the voice or speech of the user in the electronic device 101, the processor 120 may provide a UI for recording speech of the user. The UI can be presented through the display module 160 as the first option 310 is selected.

When the first option 310 is not selected (or a disable state), the processor 120 may provide an output in an audio signal processing operation with a personalized preprocessing operation excluded therefrom. The personalized preprocessing operation refers to a preprocessing operation for robust ASR that intensifies a voice or speech of a target user in an actual environment having various types of noise. The personalized preprocessing operation may be performed to remove voices or speeches of others, including various types of noise from an input audio signal, while maintaining only the voice or speech of the target user. For example, when the wake-up keyword and the PTTS audio source are included in the memory 130, the processor 120 may bring a PTTS audio recording into a personalized preprocessing engine. Alternatively, the processor 120 may share the speaker embedding vector. The processor 120 may generate the speaker embedding vector through the wake-up keyword and all audio sources including the PTTS audio source.

The wake-up keyword may include, for example, “hi bixby,” “bixby,” and a customized wake-up keyword. For example, when a wake-up keyword is registered, an audio source of the user may be stored in an internal storage (or wake-up data) of the voice assistant application. The processor 120 may copy, into the personalized preprocessing engine (e.g., a personalized preprocessing library), only an audio source of one keyword (e.g., “hi bixby”) among various wake-up keywords, and generate the speaker embedding vector using the copied keyword.

The processor 120 may determine whether the user registers his/her voice or speech. When the first option 310 is selected from information on the UI, the processor 120 may determine the presence or absence of a wake-up keyword and of an audio sound obtained from PTTS. The processor 120 may generate the speaker embedding vector by forming the audio source as an input to the library based on a result of the determining. In the presence of a plurality of audio sources, the processor 120 may generate the speaker embedding vector using all the audio sources, or generate the speaker embedding vector using only the wake-up keyword selected.

The processor 120 may adaptively perform personalized preprocessing in response to selection of a personalized option, for example, the personalized options 331, 333, and 335. For example, when the low option 331 is selected, the processor 120 may generate the speaker embedding vector using only a wake-up keyword (e.g., “hi bixby”) stored as a default.

For example, when the mid option 333 is selected, the processor 120 may provide, through the UI, feedback that a result of audio signal processing using the speaker embedding vector generated from the low option 331 is not exhibited as the user expected. The processor 120 may generate a new speaker embedding vector using another audio inside and an audio obtained through a request for recording an additional audio.

For example, when there is currently a wake-up audio source as the low option 331 is selected, the processor 120 may generate a speaker embedding vector using only the wake-up audio source (e.g., five “hi bixby” audio sources). For example, when the mid option 333 is selected, the processor 120 may generate a speaker embedding vector additionally using a recorded PTTS sentence (e.g., a PTTS audio source) including a phonetically balanced set. The phonetically balanced set may refer to a data set including sentences or words selected such that there are no omitted phonemes and the distribution of frequencies of phonemes are balanced similarly to an actual one.

For example, when the high option 335 is selected, the processor 120 may generate a robust speaker embedding vector by further requesting the user for a recorded additional speech.

For example, when the better option 353 is selected from between the noise suppression options 351 and 353, the processor 120 may determine that the user desires a more robust noise removal, and preprocess a mask by making a value less than or equal to a threshold be 0, thereby removing a greater number of noise components.

FIG. 3A illustrates an example of a UI from which no option is selected. When no option is selected, the processor 120 may process an audio signal using only a first output result without generating a second output result. The first output result may be an output result of a first speech enhancement engine to be described hereinafter, and the second output result may be an output result of a second speech enhancement engine to be described hereinafter.

FIG. 3B illustrates an example where the first option 310, the default option 311, the low option 331, and the default option 351 are selected. In this example, the processor 120 may process an audio signal by generating a speaker embedding vector using only a prestored wake-up audio source.

FIG. 3C illustrates an example where the first option 310, the default option 311, the PTTS option 315, the mid option 333, and the default option 351 are selected. In this example, the processor 120 may process an audio signal by generating a speaker embedding vector using both a wake-up audio source and a PTTS audio source.

FIG. 3D illustrates an example where the first option 310, the default option 311, the speech recording option 313, the PTTS option 315, the high option 335, and the default option 351 are selected. In this example, the processor 120 may process an audio signal by generating a speaker embedding vector using a wake-up audio source, a PTTS audio source, and an additional speech of a user.

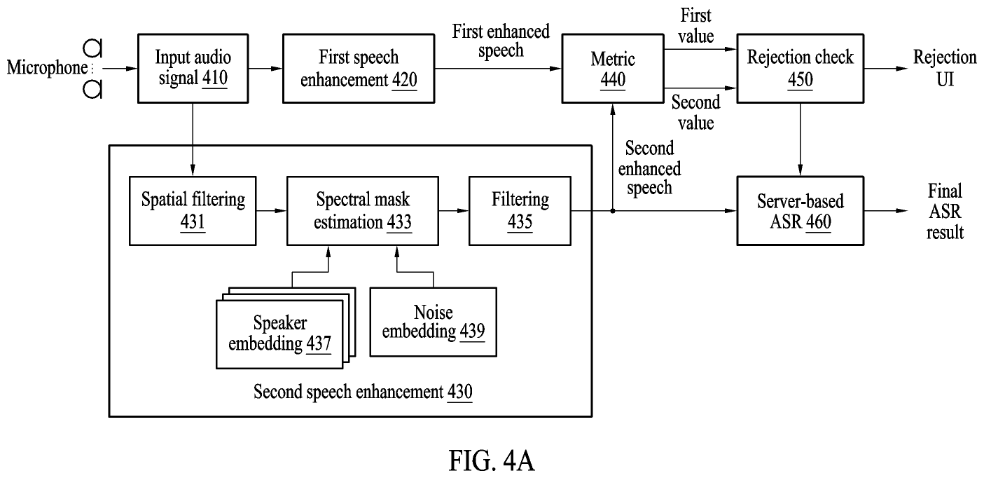

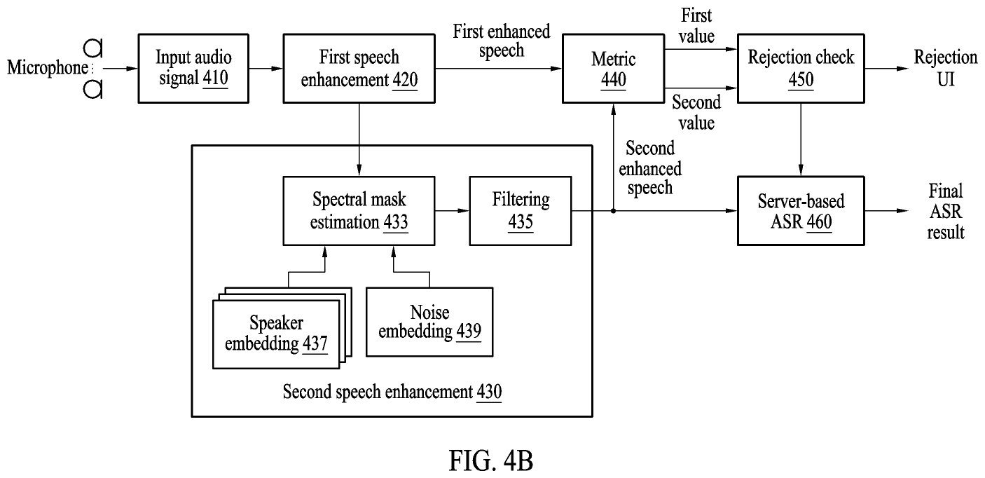

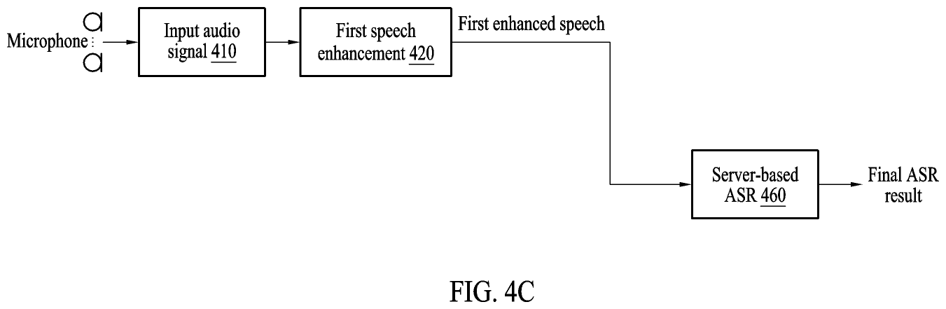

FIGS. 4A through 4C are diagrams illustrating examples of an operation of the electronic device 101 of FIG. 1.

Referring to FIGS. 4A through 4C, according to an embodiment, a microphone (e.g., the microphone 150-1 of FIG. 2) may receive an audio signal. An input audio signal module 410 may output the audio signal received from the microphone 150-1 to a first speech enhancement engine 420 and a second speech enhancement engine 430.

In FIG. 4A, an input audio signal is provided to both the first speech enhancement engine 420 and the second speech enhancement engine 430. In FIG. 4B, the output of the first speech enhancement engine 420 is provided to the second speech enhancement engine 430.

The first speech enhancement engine 420 may generate a first enhanced speech (e.g., a first output result). The second speech enhancement engine 430 may generate a second enhanced speech (e.g., a second output result). The metric module 440 receives the first enhanced speech and the second enhanced speech. The second speech enhancement engine 430 may also output the second enhanced speech to a server-based ASR module 460 (e.g., the ASR module 221 of FIG. 2).

The metric module 440 may generate a first value and a second value. The first value and the second value may be output to a rejection check module 450. For example, the metric module 440 may generate the first value and the second value using on-device ASR. The first value and the second value may be partial ASR output results that are output through the on-device ASR performed on the input first enhanced speech (e.g., the first output result) and the input second enhanced speech (e.g., the second output result), respectively. The rejection check module 450 may provide a rejection UI based on the first value and the second value. The server-based ASR module 460 may output a final ASR result.

The processor 120 may determine a preprocessing mode based on the presence or absence of a speaker embedding vector. In the presence of the speaker embedding vector, the processor 120 may perform preprocessing simultaneously using the first speech enhancement engine 420 and the second speech enhancement engine 430 as shown in FIG. 4A or FIG. 4B. Conversely, in the absence of the speaker embedding vector, the processor 120 may perform preprocessing using only the first speech enhancement engine 420, as shown in FIG. 4C.

The first speech enhancement engine 420 may be configured in a general audio signal processing form, instead of a noise removal (e.g., speaker separation) form based on information of a user, and remove general background noise by perceiving utterances of others as a voice or speech. That is, the first speech enhancement engine 420 may be configured to perform signal processing to enhance speech, regardless of the speaker.

The second speech enhancement engine 430 may remove utterances of others and remove noise while maintaining only a speech or voice of a target (user by performing personalized preprocessing based on information of the user. That is, the second speech enhancement engine 430 may be configured to perform signal processing to enhance the target user's speech from the speech of other speakers.

The first speech enhancement engine 420 may process the received audio signal to enhance the sound quality corresponding to the audio signal. The first speech enhancement engine 420 may include, for example, at least one of an adaptive echo canceller (AEC) configured to remove echo, a noise suppression module (or an NS module), or an automatic gain control (AGC) module.

The processor 120 may generate the first output result by removing noise from the audio signal. The processor 120 may generate the first output result by removing the noise from the audio signal through the first speech enhancement engine 420.

The processor 120 may generate the second output result by performing speaker separation, either on the audio signal, or on the first output result. The processor 120 may generate a plurality of speaker embedding vectors based on the audio signal. The speaker embedding vectors can encode the speaker characteristics of an utterance into a fixed-length vector using neural networks. The vector can be a data structure with different values for predetermined set of characteristics.

The processor 120 may generate the second output result by performing the speaker separation through the second speech enhancement engine 430. FIG. 4A illustrates an example where the second speech enhancement engine 430 receives, as an input, an original audio signal (e.g., a raw mic input signal) and processes the audio signal without a change. FIG. 4B illustrates an example where the second speech enhancement engine 430 receives, as an input, a processing result (e.g., a first output) obtained from the first speech enhancement engine 420 and performs mask estimation.

Referring to FIG. 4A, the second speech enhancement engine 430 may include a spatial filtering module 431, a spectral mask estimation module 433, a filtering module 435, a speaker embedding module 437, and a noise embedding module 439.

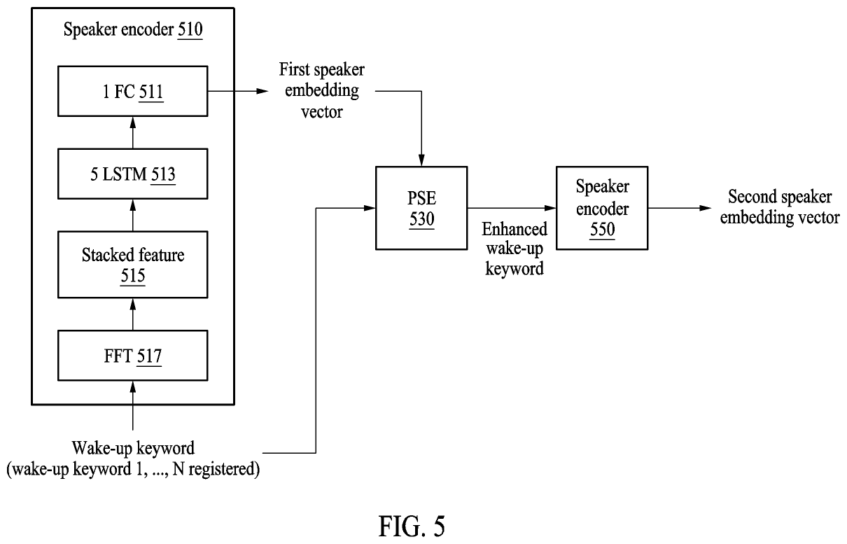

The speaker embedding module 437 may generate an embedding vector using an encoding network and a preprocessing network, such as shown in FIG. 5. For example, the speaker embedding module 437 may generate a first speaker embedding vector by inputting the audio signal to a first encoding network. The speaker embedding module 437 may generate a second speaker embedding vector by inputting the first speaker embedding vector to a first preprocessing network. The speaker embedding module 437 may generate the second speaker embedding vector by inputting an output of the first preprocessing network to a second encoding network. The speaker embedding module 437 may generate the second output result by inputting the second speaker embedding vector to a second preprocessing network.

The processor 120 may effectively remove noise and maintain only a speech of a target speaker by performing filtering based on an influence of the surroundings on noise, using both the speaker embedding module 437 and the noise embedding module 439. The processor 120 may add a spatial information feature to an input signal of a multi-channel microphone (or a plurality of microphones) by using the spatial filtering module 431, or perform mask estimation on an input preprocessed by the speaker embedding module 437 by using the spectral mask estimation module 433.

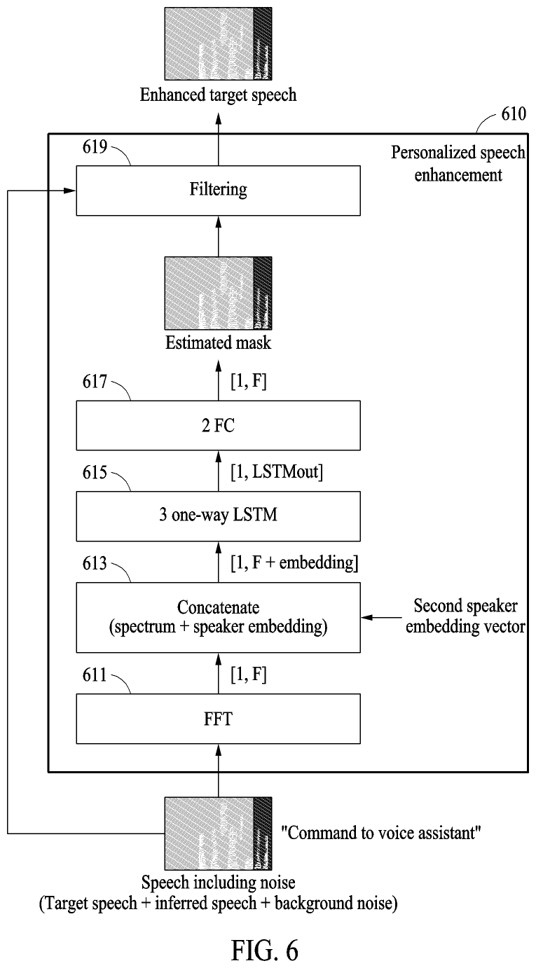

The first encoding network, the second encoding network, the first preprocessing network, and the second preprocessing network may include at least one long short-term memory (LSTM) network. A network structure will be described in detail with reference to FIGS. 5 and 6.

The processor 120 may generate the second output result (“second enhanced speech”) by performing the mask estimation based on the speaker embedding vectors. The processor 120 may generate the second output result by performing the spatial filtering on the audio signal and performing the mask estimation based on an audio signal obtained through the spatial filtering.

The processor 120 may determine the presence or absence of the second output result. When the second output is present, the processor 120 determines that a command corresponding to the audio signal is by the user. The processor 120 may provide feedback corresponding to the command based on a result of determining whether the command is by the user. The processor 120 may process the command corresponding to the audio signal based on the first output result and the second output result. The processor 120 may determine whether the command is by the user based on a difference between the first output result and the second output result, and provide the feedback corresponding to the command based on a result of the determining.

The processor 120 may maintain voice or speech of the user, alone, and remove a voice or speech of another interfering speaker using the embedding vectors. The processor 120 may output a corresponding result to the server-based ASR module 460.

For example, in a case where a first option (e.g., the first option 310 of FIG. 3A) is selected, the processor 120 may provide, as feedback, a UI (or a rejection UI) indicating “unable to perform” when an audio signal including a command of another person different the user is received.

When a voice or speech of another person besides the user is input, the metric module 440 may perform a determination to provide the reject UI. The metric module 440 may determine the presence or absence of an utterance of another person besides the user using a difference between the first output result and the second output result.

The server-based module ASR 460 may be replaced with an on-device ASR module. The on-device ASR module may be used for a rejection check, and be implemented as the same or similar configuration as the server-based ASR module 460 in the electronic device 101 when it outputs an actual final ASR result. Alternatively, when outputting the actual final ASR result, the server-based ASR module 460 may be replaced with a second on-device ASR module.

When an utterance of another person besides the user is received, the utterance of the other person may be removed from an output of the second preprocessing network used by the speaker embedding module 437. Thus, the processor 120 may provide feedback indicating that it is unable to perform a command of the other person who is different from the user, using only the second output result.

The processor 120 may verify a partial ASR result, and determine a magnitude of the difference between the first output result and the second output result. The processor 120 may determine whether the second output result is close to empty, and provide feedback indicating that it is unable to perform the command before obtaining a final ASR result.

The examples of FIGS. 4A and 4B illustrate operations performed when a first option (e.g., the first option 310 of FIG. 3A) is selected. For initially processing the audio signal, when there is a wake-up keyword, the processor 120 may verify whether there is “hi bixby,” “bixby,” and/or a customized wake-up keyword in the memory 130, and generate a speaker embedding vector based on the user speaking the wake-up keyword. That is, the utterance of the wake-up keyword is a good sample of the user's voice, which allows for creation of a speaker embedding vector. When there is not an audio source in the wake-up keyword but there is a PTTS audio source, the processor 120 may use the PTTS audio source. When both the wake-up keyword and the PTTS audio source of the user are not present in the electronic device 101, the processor 120 may provide a UI to prompt the user to provide a new recording. The processor 120 may generate a speaker embedding vector from the new recording, and may then provide an audio signal preprocessed through the second speech enhancement engine 430.

For example, when the first option 310 is selected and the speaker embedding vector is previously present (or is stored in the memory 130), the processor 120 may generate the second output result through the second speech enhancement engine 430 using the present speaker embedding vector. In this example, the processor 120 may use a plurality of audio sources as an input of an encoder for generating the speaker embedding vector. First, the processor 120 may invoke an audio source most recently stored in the memory 130. In this case, a wake-up keyword and a registered PTTS audio source in the memory 130 may be an audio source recorded by the user. An audio source may have an identification (ID) allocated randomly for protecting personal information. By assuming that, in addition to the wake-up keyword most recently stored in the memory 130, an audio additionally recorded to improve the accuracy in invoking a voice or speech is an audio source recorded by the voice of the user, the processor 120 may use the audio source to generate a speaker embedding vector. In addition, when performing an additional recording according to the first option 310, the processor 120 may use the additionally recorded audio as the voice of the user.

The example of FIG. 4C illustrates operations performed when a first option (e.g., the first option 310 of FIG. 3A) is not selected (or is disabled). When the first option 310 is not selected, the processor 120 may process an audio using only the first speech enhancement engine 420 without using the speaker embedding vector, and output a result of the processing to the server-based ASR module 460.

FIG. 5 is a diagram illustrating an example of a network for generating an embedding vector according to an embodiment, and FIG. 6 is a diagram illustrating an example of a network for generating an output result according to an embodiment.

Referring to FIGS. 5 and 6, according to an embodiment, a processor (e.g., the processor 120 of FIG. 1) may process an audio signal using a neural network.

The processor 120 may generate a first speaker embedding vector by inputting the audio signal or first output result to a first encoding network. The processor 120 may generate a second speaker embedding vector by inputting the first speaker embedding vector to a first preprocessing network. The processor 120 may generate the second speaker embedding vector by inputting an output of the first preprocessing network to a second encoding network. The processor 120 may generate a second output result by inputting the second speaker embedding vector to a second preprocessing network.

At least one of the first encoding network, the first preprocessing network, the second encoding network, and the second preprocessing network may include a neural network.

The neural network may refer to an overall model having a problem-solving ability obtained as artificial neurons (nodes) forming a network through synaptic connections change the strength of the synaptic connections through learning.

A neuron of the neural network may include a combination of weights or biases. The neural network may include one or more layers including one or more neurons or nodes. The neural network may infer a result desired to be predicted from an input by changing a weight of a neuron through learning.

The neural network may include a deep neural network (DNN). The neural network may include, for example, a convolutional neural network (CNN), a recurrent neural network (RNN), a perceptron, a multilayer perceptron, a feedforward (FF) network, a radial basis function (RBF) network, a deep FF (DFF) network, an LSTM, a gated recurrent unit (GRU), an autoencoder (AE), a variational AE (VAE), a denoising AE (DAE), a sparse AE (SAE), a Markov chain (MC), a Hopfield network (HN), a Boltzmann machine (BM), a restricted BM (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

The processor 120 may generate a speaker embedding vector through fine tuning while additionally performing learning or training using a speaker embedding vector-based loss for learning or training of a preprocessing network.

The first encoding network may include a speaker encoder 510 of FIG. 5. The speaker encoder 510 may perform a fast Fourier transform (FFT) 517 by receiving a wake-up keywork, and obtain a staked feature 515 from a result of the FFT 517. For example, when five audio signals (e.g., sample 1.wav, . . . , and sample 5.wav) of a registered speaker uttering a wake-up keyword (e.g., “hi bixby”) are stored in the memory 130, the processor 120 may concatenate the five audio signals and extract only an interval (e.g., [sample1_voiceonly, sample2_voiceonly, . . . , and sample5_voiceonly]) where a voice or speech of the registered speaker, exclusive of silence, is present. The stacked feature 515 may have resultant values obtained by performing an FFT on an interval where only a voice or speech of the registered user is present for each frame unit. The stacked feature 515 may be input to an LSTM 513, and an output of the LSTM 513 may be input to a fully-connected (FC) layer 511. The first speaker embedding vector (e.g., a first speaker embedding vector) may thereby be generated. Although the LSTM 513 is illustrated as being five layers in FIG. 5, the number of LSTMs may vary.

The first speaker embedding vector may be input to the first preprocessing network. The first preprocessing network may include a personalized speech enhancement (PSE) module 530. The processor 120 may use, as a loss, a Euclidian distance between a ground truth clean spectrogram and an estimated clean spectrogram (e.g., an output of the PSE module 530), and update weights of the first encoding network and the first preprocessing network to reduce the loss. The processor 120 may also update weights of the LSTM 513 and the FC layer 511 of the speaker encoder 510 in addition to a weight of the PSE module 530. The processor 120 may thereby additionally tune the pre-trained speaker encoder 510 to a speaker recognition task according to the PSE module 530.

The processor 120 may extract the first speaker embedding vector from the wave samples of the wake-up keyword, and extract the second speaker embedding vector after processing the first speaker embedding vector with the first preprocessing network, thereby removing noise included in a registered audio source. Thus, the second speaker embedding vector may be less affected by noise than the first speaker embedding vector, and more accurately reflect therein utterance information of the registered speaker. When an audio source (e.g., a PTTS audio source) more suitable for performance improvement is additionally registered in addition to the wake-up keyword, the processor 120 may use a value extracted from the added audio source in replacement of a speaker embedding vector.

The processor 120 may extract spectral information from the wake-up keyword and use the spectral information as an input of the speaker encoder 510. In the example of FIG. 5, after the FFT 517, a logMel feature maybe used, in lieu of a spectrum, as an input of the speaker encoder 510.

The number of LSTMs may be greater than or less than five. For example, the number of LSTMs may be three. In this example, LSTM layers may be provided in a many-to-one form and may use only an output node of a final frame after receiving frames up to the final frame without using an output of all the input frames. The processor 120 may also use a method of obtaining an average of outputs of all the frames in a many-to-many output form, without limiting a length of a registered utterance.

The processor 120 may generate the second output result based on the second speaker embedding vector (e.g., a second speaker embedding vector). The processor 120 may generate the second output result by inputting the second speaker embedding vector to the second preprocessing network (e.g., a second preprocessing network 610 of FIG. 6).

According to an embodiment, the second preprocessing network 610 may receive an audio signal (e.g., a speech including noise) and perform an FFT 611. The processor 120 may perform concatenation 613 to concatenate a result of the FFT 611 and a second embedding vector. The processor 120 may input a result of the concatenation 613 to an LSTM 615. The LSTM 615 may include three one-way LSTM layers. The processor 120 may obtain an estimated mask by inputting an output of the LSTM 615 to an FC layer 617. The FC layer 617 may include two layers. The processor 120 may perform filtering 619 on the estimated mask to obtain a second output result (e.g., an enhanced target speech).

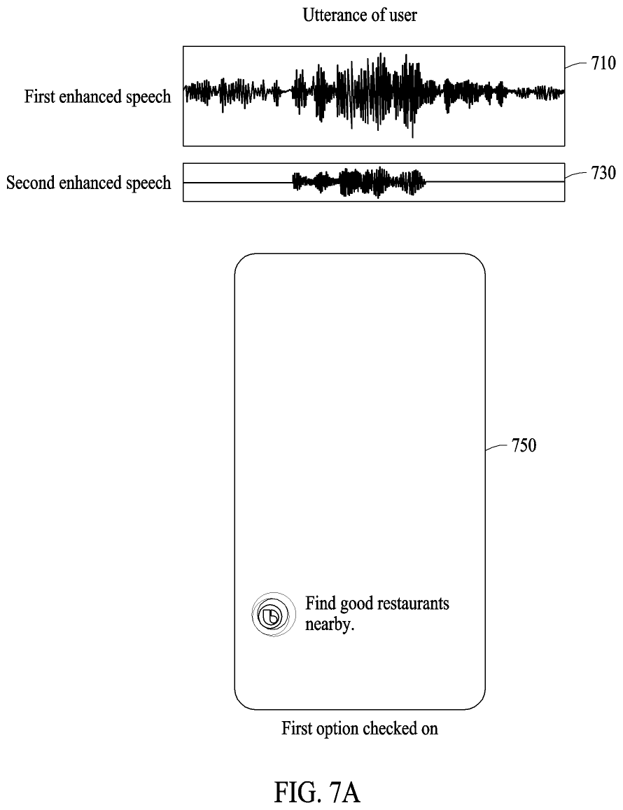

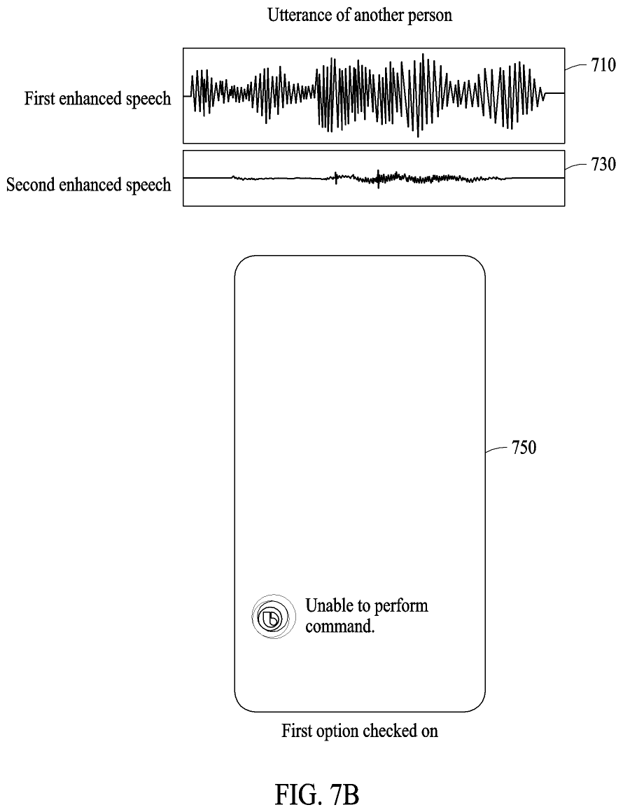

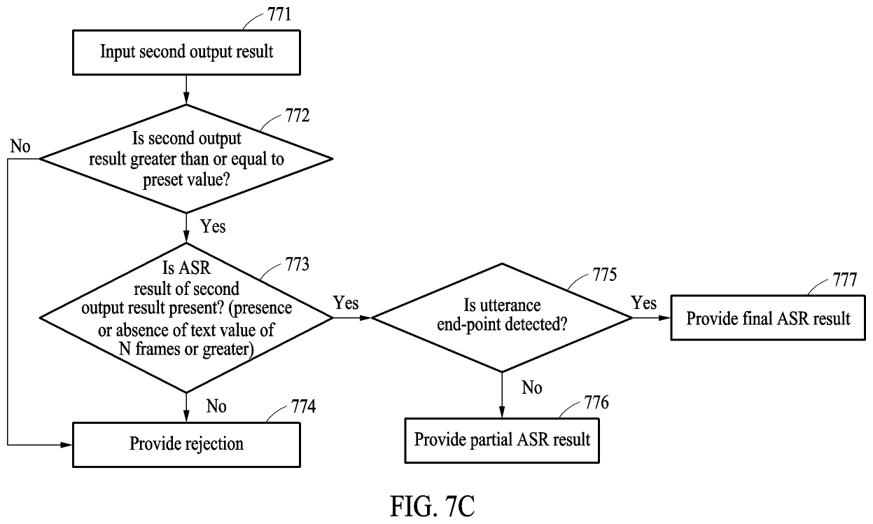

FIGS. 7A through 7C are diagrams illustrating examples of a first output result and a second output result according to an embodiment.

Referring to FIGS. 7A and 7B, according to an embodiment, a processor (e.g., the processor 120 of FIG. 1) may generate a first output result 710 by removing noise from an audio signal. The first output result 710 may include a first enhanced speech.

The processor 120 may generate a second output result 730 by performing speaker separation based on the audio signal and the first output result 710. The second output result 730 may include a second enhanced speech. The processor 120 may generate a plurality of speaker embedding vectors based on the audio signal, and generate the second output result 730 by performing mask estimation based on the speaker embedding vectors.

The processor 120 may generate a first speaker embedding vector by inputting the audio signal to a first encoding network, and generate a second speaker embedding vector by inputting the first speaker embedding vector to a first preprocessing network. The processor 120 may generate the second speaker embedding vector by inputting an output of the first preprocessing network to a second encoding network. The processor 120 may generate the second output result 730 by inputting the second speaker embedding vector to a second preprocessing network.

The processor 120 may process a command corresponding to the audio signal based on the first output result 710 and the second output result 730. The processor 120 may determine whether the command is by a user based on a difference between the first output result 710 and the second output result 730, and provide feedback 750 corresponding to the command based on a result of the determining.

The difference between the first output result 710 and the second output result 730 may be shown as in FIG. 7A when an utterance of the user is present and be shown as in FIG. 7B when an utterance of another person is present.

The processor 120 may determine whether the second output result 730 is present and determine whether a command is by the user based on a result of the determining. The processor 120 may provide feedback corresponding to the command based on a result of determining whether the command is by the user.

When a first option is selected, the processor 120 may provide, through a display module, a partial ASR output using server-based ASR with the second output result 730 as an input. The processor 120 may continuously verify whether only a value less than or equal to a preset value is output while verifying the second output result 730. For example, the processor 120 may continuously verify an average output magnitude of the second output result 730 for a predetermined period of time and/or a real-time output magnitude of the second output result 730. When a value of the second output result 730 is greater than or equal to the preset value, the processor 120 may verify an ASR output by verifying a result of on-device ASR.

Referring to FIG. 7C, in operation 771, the processor 120 may receive the second output result 730. In operation 772, in a situation where rejection is needed, the processor 120 may verify whether a value less than or equal to a preset value (e.g., a threshold value) is continuously output by verifying the second output result 730. In operation 773, when the value of the second output result 730 greater than or equal to the preset value is output, the processor 120 may verify whether an ASR value calculated with the second output result 730 is present. For example, when a text value is present for a preset or greater number of frames of the second output result 730, the processor 120 may verify the presence of the ASR value calculated with the second output result 730. In this example, the preset number may be N which is a natural number. In operation 774, when the ASR value calculated based on the second output value 730 is not present, the processor 120 may provide a rejection UI. For example, the rejection UI may include a text message indicating, for example, “unable to perform the command.” In operation 775, when the ASR value calculated based on the second output value 730 is present, the processor 120 may verify whether an end point of an utterance is detected.

For example, when a voice or speech is not present for a predetermined period of time, the processor 120 may verify that the end point of the utterance is detected as the utterance is ended, using a voice activity detection (VAD) technique. In operation 776, when the end point of the utterance is not detected, the processor 120 may provide a partial ASR result. In operation 777, when the end point of the utterance is detected, the processor 120 may correct the ASR result of the second output result 730 to be a final ASR result and provide the final ASR result.

In a case where there is no on-device ASR, the processor 120 may verify a server-based ASR result and verify an ASR output, when the value of the second output result 730 greater than or equal to the preset value is output.

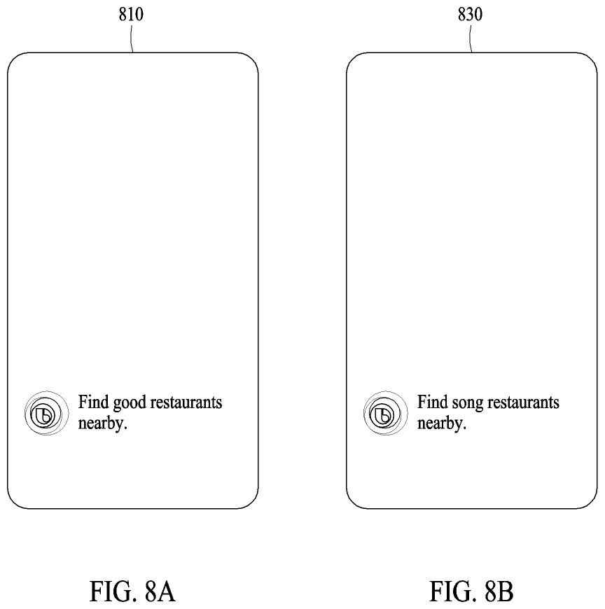

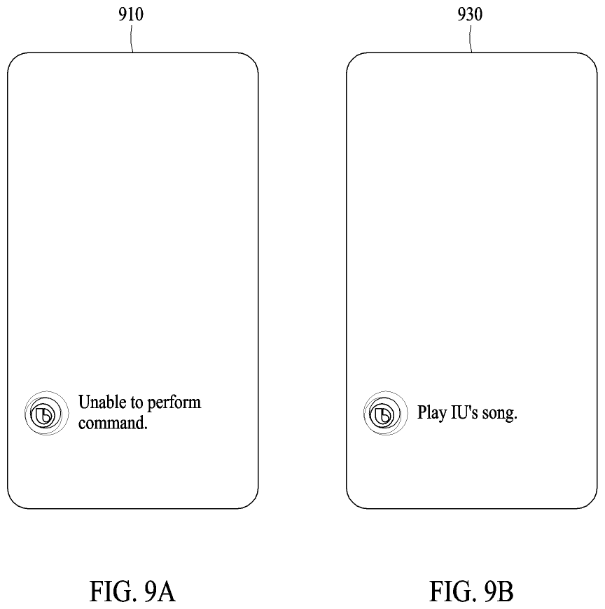

FIGS. 8A through 9B are diagrams illustrating examples of a result of processing a command of a user in response to selection of options from a UI according to embodiments.

FIG. 8A illustrates a result of processing an audio signal when a first option (e.g., the first option 310 of FIG. 3A) is selected, and FIG. 8B illustrates a result of processing an audio signal when the first option 310 is not selected.

For example, when a first speaker is a user of an electronic device (e.g., the electronic device 101 of FIG. 1), a microphone (e.g., the microphone 150-1 of FIG. 2) may receive an audio signal corresponding to “find good restaurants nearby” from the first speaker. In this example, when receiving an audio signal corresponding to “play some IU's song” from a second speaker in the case where the first option 310 is selected, a processor (e.g., the processor 120 of FIG. 1) may accurately recognize a command corresponding to “find good restaurants nearby” from the first speaker and process the command while providing feedback 810, by generating a second output result using an embedding vector described above.

In contrast, in the case where the first option 310 is not selected, the processor 120 may not distinguish the audio signal of the first speaker and the audio signal of the second speaker and output a distorted result such as, for example, “find song restaurants nearby,” while providing feedback 830 as illustrated in FIG. 8B.

Referring to FIG. 9A, in a case in which the first speaker is the user of the electronic device 101, when the microphone 150-1 does not receive any audio signal from the first speaker but receive an audio signal corresponding to “play some IU's songs” from the second speaker, and the first option 310 is selected, the processor 120 may generate a second output result using an embedding vector described above, and provide feedback 910 corresponding to “unable to perform the command.”

Referring to FIG. 9B, when the first option 310 is not selected, the processor 120 may not distinguish the audio signal of the first speaker and the audio signal of the second speaker, and perform a command of the second speaker while providing feedback 930.

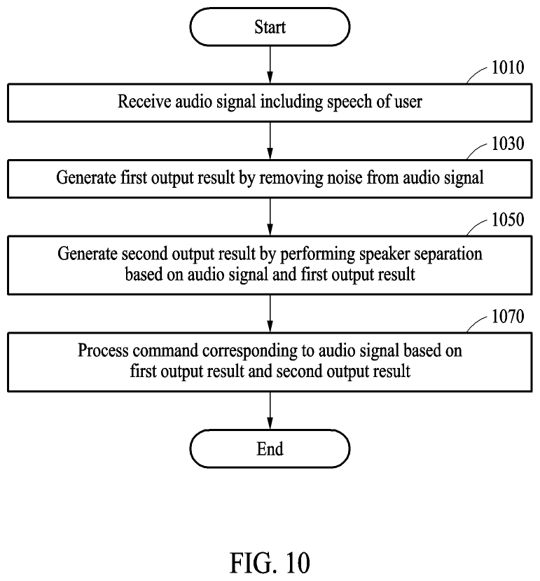

FIG. 10 is a flowchart illustrating an example of a method of operating the electronic device 101 of FIG. 1.

Referring to FIG. 10, according to an embodiment, in operation 1010, a microphone (e.g., the microphone 150-1 of FIG. 2) may receive an audio signal including a speech of a user.

In operation 1030, a processor (e.g., the processor 120 of FIG. 1) may generate a first output result by removing noise from the audio signal.

In operation 1050, the processor 120 may generate a second output result by performing speaker separation based on the audio signal and the first output result. The processor 120 may generate the second output result by generating a plurality of embedding vectors based on the audio signal and performing mask estimation based on the embedding vectors.

For example, the processor 120 may generate a first embedding vector included in the embedding vectors by inputting the audio signal to a first encoding network, and generate a second embedding vector included in the embedding vectors by inputting the first embedding vector to a first preprocessing network. The processor 120 may generate the second embedding vector by inputting an output of the first preprocessing network to a second encoding network. The processor 120 may generate the second output result by inputting the second embedding vector to a second preprocessing network.

The first encoding network, the second encoding network, the first preprocessing network, and the second preprocessing network may include at least one LSTM network.

The processor 120 may generate the second output result by performing spatial filtering on the audio signal and performing mask estimation based on an audio signal obtained through the spatial filtering.

In operation 1070, the processor 120 may process a command corresponding to the audio signal based on the first output result and the second output result. The processor 120 may determine whether the command is by the user based on a difference between the first output result and the second output result, and provide feedback corresponding to the command based on a result of the determining.

According to an embodiment, an electronic device (e.g., the electronic device 101 of FIG. 1) may include a microphone (e.g., the microphone 150-1 of FIG. 1) configured to receive an audio signal including a speech of a user, a memory (e.g., the memory 130 of FIG. 1) including therein instructions, and a processor (e.g., the processor 120 of FIG. 1) electrically connected to the memory 130 and configured to execute the instructions.

When the instructions are executed by the processor 120, the processor 120 may perform a plurality of operations, the plurality of operations comprising removing noise from the audio signal, thereby generating a first output result, performing speaker separation based on the audio signal or the first output result, thereby generating a second output result, and procesings a command corresponding to the audio signal based on the first output result and the second output result.

The processor 120 may generate the second output result by generating a plurality of speaker embedding vectors based on the audio signal or the firsts output result and performing mask estimation based on the plurality of speaker embedding vectors.

The plurality of operations may further comprise inputting the audio signal to a first encoding network, thereby generating a first speaker embedding vector, inputting the first speaker embedding vector to a first preprocessing network, thereby generating a second speaker embedding vector.

The plurality of operations may further comprise inputting an output of the first preprocessing network to a second encoding network.

The plurality of operations may further comprise inputting the second embedding vector to a second preprocessing network.

The first encoding network, the second encoding network, the first preprocessing network, and the second preprocessing network may include at least one LSTM network.

The plurality of operations may further comprise spatial filtering on the audio signal or the first output result, and performing mask estimation based on an output of the spatial filtering.

The plurality of operations may further comprise determining whether the second output result is present, determining whether the command is by the user based on a result of determining whether the second output result is present, and providing feedback corresponding to the command based on a result of determining whether the command is by the user.

The processor 120 may determine whether the command is by the user based on a difference between the first output result and the second output result, and provide feedback corresponding to the command based on a result of the determining.

According to an embodiment, an electronic device (e.g., the electronic device 101) may include a microphone configured to receive an audio signal including a speech of a user, a memory (e.g., the memory 130) storing therein instructions, and a processor (e.g., the processor 120) electrically connected to the memory 130 and configured to execute the instructions.

When the instructions are executed by the processor 120, the processor 120 may perform a plurality of operations, the plurality of operations comprising: determining an audio signal preprocessing mode in response to a first option being selected through a UI, determining a type of input data for processing the audio signal in response to a second option being selected through the UI, and processing a command corresponding to the audio signal based on the preprocessing mode and the type of the input data.

As the first option is selected, the processor 120 may determine whether to perform speaker separation on the audio signal.

As the second option is selected, the processor 120 may determine, to be the input data, at least one of a wake-up keyword uttered by the user, a PTTS audio source, and an additional speech of the user.

The plurality of operations may further comprise removing noise from the audio signal, thereby generating a first output result, performing the speaker separation on the audio signal or the first output result based on the preprocessing mode and the type of the input data, thereby generating a second output result, and processing the command corresponding to the audio signal based on the first output result and the second output result.

The processor 120 may generate the second output result by generating a plurality of speaker embedding vectors based on the audio signal and performing mask estimation based on the plurality of speaker embedding vectors.

The processor 120 input the audio signal to a first encoding network, thereby generating the first speaker embedding vector, and input the first embedding vector to a first preprocessing network, thereby generating a second speaker embedding vector.

The processor 120 may input an output of the first preprocessing network to a second encoding network, thereby generating the second speaker embedding vector.

The processor 120 may input the second embedding vector to a second preprocessing network, thereby generating the second output result.

The first encoding network, the second encoding network, the first preprocessing network, and the second preprocessing network may include at least one LSTM network.

The processor 120 may input the second speaker embedding vector to the second preprocessing network, thereby generating the second output result.

According to an embodiment, a method of operating an electronic device (e.g., the electronic device 101) may include receiving an audio signal including a speech of a user, removing noise from the audio signal, thereby generating a first output result, performing speaker separation based on the audio signal, thereby generating a second output result, and processing a command corresponding to the audio signal based on the first output result and the second output result.

The embodiments described herein are provided merely for better understanding of the disclosure, and the disclosure should not be limited thereto or thereby. It should be appreciated by one of ordinary skill in the art that various changes in form or detail may be made to the embodiments without departing from the scope of this disclosure as defined by the following claims, and equivalents thereof.

What is claimed is:

1. An electronic device, comprising:
a microphone configured to receive an audio signal comprising a speech of a user;
a memory storing instructions therein; and
a processor electrically connected to the memory and configured to execute the instructions,
wherein execution of the instructions by the processor, causes the processor to perform a plurality of operations, the plurality of operations comprising:
removing noise from the audio signal, thereby generating a first output result;
performing speaker separation on the audio signal on the audio signal, thereby generating a second output result; and
processing a command corresponding to the audio signal based on the first output result and the second output result.

2. The electronic device of claim 1, wherein the plurality of operations further comprises:
generating a plurality of speaker embedding vectors based on the audio signal; and
generating the second output result by performing mask estimation based on the plurality of speaker embedding vectors.

3. The electronic device of claim 2, wherein the plurality of operations further comprises:
inputting the audio signal to a first encoding network, thereby generating a first speaker embedding vector; and
inputting the first speaker embedding vector to a first preprocessing network, thereby generating a second speaker embedding vector.

4. The electronic device of claim 3, wherein inputting the first speaker embedding vector comprises inputting an output of the first preprocessing network to a second encoding network.

5. The electronic device of claim 4, wherein the plurality of operations further comprises:
inputting the second speaker embedding vector to a second preprocessing network, thereby generating the second output result.

6. The electronic device of claim 5, wherein the first encoding network, the second encoding network, the first preprocessing network, and the second preprocessing network comprise at least one long short-term memory (LSTM) network.

7. The electronic device of claim 1, wherein the plurality of operations further comprises:
spatial filtering the audio signal or the first output result; and
performing mask estimation based on the spatial filtering.

8. The electronic device of claim 1, wherein the plurality of operations further comprises:
determining the presence or absence of the second output result;
determining whether the command is by the user based on the presence or absence of the second output result; and
providing feedback corresponding to the command based on a result of determining whether the command is by the user.

9. The electronic device of claim 1, wherein the plurality of operations further comprises:
determining whether the command is by the user based on a difference between the first output result and the second output result; and
providing feedback corresponding to the command based on a result of the determining.

10. An electronic device, comprising:
a microphone configured to receive an audio signal comprising a speech of a user;
a memory storing therein a plurality of instructions; and
a processor electrically connected to the memory and configured to execute the plurality of instructions,
wherein, when the plurality of instructions are executed by the processor, the instructions cause the processor to perform a plurality of operations, the plurality of operations comprising:
determining a preprocessing mode for the audio signal as a first option is selected through a user interface (UI);
determining a type of input data for processing the audio signal as a second option is selected through the UI; and
processing a command corresponding to the audio signal based on the preprocessing mode and the type of the input data.

11. The electronic device of claim 10, wherein the processor is configured to:
determine whether to perform speaker separation on the audio signal as the first option is selected.

12. The electronic device of claim 10, wherein the plurality of operations further comprises:
determining, to be the input data, at least one of a wake-up keyword uttered by the user, a personalized text-to-speech (PTTS) audio source, or an additional speech of the user, as the second option is selected.

13. The electronic device of claim 10, wherein the plurality of operations further comprises:
removing noise from the audio signal, thereby generating a first output result;
performing speaker separation on the audio signal, based on the preprocessing mode and the type of the input data, thereby generating a second output result; and
processing the command corresponding to the audio signal based on the first output result and the second output result.

14. The electronic device of claim 13, wherein the plurality of operations further comprises:
generate a plurality of speaker embedding vectors based on the audio signal; and
generate the second output result by performing mask estimation based on the plurality of speaker embedding vectors.

15. The electronic device of claim 14, wherein the plurality of operations further comprises:
inputting the audio signal or first output result to a first encoding network, thereby generating a first speaker embedding vector; and
inputting the first speaker embedding vector to a first preprocessing network, thereby generating a second speaker embedding vector.

16. The electronic device of claim 15, wherein the plurality of operations further comprises:
inputting an output of the first preprocessing network to a second encoding network, thereby generating the second speaker embedding vector.

17. The electronic device of claim 16, wherein the plurality of operations further comprises:
inputting the second speaker embedding vector to a second preprocessing network, thereby generating the second output result.

18. The electronic device of claim 17, wherein the first encoding network, the second encoding network, the first preprocessing network, and the second preprocessing network comprise at least one long short-term memory (LSTM) network.

19. The electronic device of claim 18, wherein the plurality of operations further comprises:
inputting the second speaker embedding vector to the second preprocessing network, thereby generating the second output result.

20. A method of operating an electronic device, comprising:
receiving an audio signal comprising a speech of a user;
removing noise from the audio signal, thereby generating a first output result;
performing speaker separation on the audio signal or the first output result, thereby generating a second output result; and
processing a command corresponding to the audio signal based on the first output result and the second output result.
